(19) United States
(12) Patent Application Publication
(10) Pub. No.: US 2021/0344008 A1
(43) Pub. Date: Nov. 4, 2021

(54) SECONDARY BATTERY AND METHOD OF MANUFACTURING SAME

(71) Applicant: Panasonic Intellectual Property Management Co., Ltd., Osaka-shi, Osaka (JP)

(72) Inventors: Takayuki Nakatsutsumi, Osaka (JP); Kazuhiro Iida, Osaka (JP); Atsushi Fukui, Hyogo (JP)

(73) Assignee: Panasonic Intellectual Property Management Co., Ltd., Osaka-shi, Osaka (JP)

(21) Appl. No.: 17/259,722

(22) PCT Filed: Feb. 21, 2019
(86) PCT No.: PCT/JP2019/006654

§ 371 Date: Jan. 12, 2021

(30) Foreign Application Priority Data
Jul. 27, 2018 (JP) 2018-141732

(51) Int. Cl. H01M 4/525; H01M 10/0567; H01M 10/0569; H01M 10/058; H01M 4/131; H01M 4/505; H01M 10/0525; H01M 4/583

(52) U.S. Cl. CPC H01M 4/525; H01M 10/0567; H01M 10/0569; H01M 4/5835; H01M 4/131; H01M 4/505; H01M 10/0525; H01M 10/058

(57) ABSTRACT

A secondary battery includes a positive electrode containing a positive electrode active material; a negative electrode; and an electrolyte. The electrolyte contains a solvent, a lithium salt dissolved in the solvent, and a film forming compound. The film forming compound includes fluorine and an unsaturated bond between carbons. A surface of the positive electrode active material is at least partially covered with a film containing lithium, oxygen, carbon, and fluorine.

### TECHNICAL FIELD

The present invention relates to a secondary battery and a method for manufacturing the same.

### BACKGROUND ART

In association with charge/discharge, at a surface of a positive/negative electrode active material of a secondary battery, such as a lithium ion battery, an electrolyte containing a nonaqueous solvent and a lithium salt are partially able to irreversibly react with each other.

Patent Document 1 has disclosed that when trifluoromethyl maleic anhydride is added to an electrolyte liquid, by an SEI (Solid Electrolyte Interphase) film formed on a negative electrode surface, an irreversible reaction at the negative electrode surface is suppressed. In general, the SEI film has a lithium ion permeability.

### CITATION LIST

### Patent Literature

Patent Document 1: Japanese Published Unexamined Patent Application No. 2007-317647

### SUMMARY OF INVENTION

### Technical Problem

In a general charge/discharge reaction, at a positive electrode side, by an oxidation reaction of an additive and the like contained in an electrolyte, a film can be formed on a positive electrode surface. However, the film formed by the oxidation reaction has a low lithium ion conductivity, and an internal resistance thereof is liable to increase.

### Solution to Problem

According to an aspect of the present disclosure, there is provided a secondary battery which comprises a positive electrode containing a positive electrode active material; a negative electrode; and an electrolyte, the electrolyte contains a solvent, a lithium salt dissolved in the solvent, and a film forming compound, the film forming compound includes fluorine and an unsaturated bond between carbons, and a surface of the positive electrode active material is at least partially covered with a film containing lithium, oxygen, carbon, and fluorine.

According to another aspect of the present disclosure, there is provided a method for manufacturing a secondary battery, the method comprising: a step of assembling a secondary battery which includes a positive electrode, a negative electrode, and an electrolyte; and a film forming step of dipping the positive electrode in a solution containing a lithium salt and a film forming compound which includes fluorine and an unsaturated bond between carbons to cover a surface of the positive electrode with a film formed by reductive decomposition of the film forming compound.

### Advantageous Effects of Invention

According to the above aspect of the present disclosure, a secondary battery including a film having not only an excellent lithium ion conductivity but also a high oxidation resistance on a positive electrode surface can be obtained.

Accordingly, a secondary battery having a low internal resistance and high cycle characteristics can be realized.

Although novel features of the present invention will be described in the attached claims, the present invention is to be further deeply understood in terms of both the structure and the content by the following detailed description with reference to the drawings in combination with the other object and features of the present invention.

### BRIEF DESCRIPTION OF DRAWINGS

FIG. 1 is a partially notched perspective view of a secondary battery according to an embodiment of the present disclosure.

FIG. 2 is a graph showing a capacity retention rate at each charge/discharge cycle of a secondary battery of each of an example and comparative examples.

### DESCRIPTION OF EMBODIMENTS

A secondary battery according to an embodiment of the present disclosure comprises: a positive electrode containing a positive electrode active material; a negative electrode; and an electrolyte. The electrolyte contains a solvent, a lithium salt dissolved in the solvent, and a film forming compound. The film forming compound includes fluorine and an unsaturated bond (hereinafter, also referred to as “CC unsaturated bond” in some cases) between carbons. A surface of the positive electrode active material is at least partially covered with a film containing lithium, oxygen, carbon, and fluorine.

The film containing lithium, oxygen, carbon, and fluorine is excellent in lithium ion conductivity and also has a high oxidation resistance. Since the film contains lithium, it is believed that a lithium transfer resistance is decreased. In addition, since the film contains fluorine, it is believed that the oxidation resistance of the film is improved. Since the surface of the positive electrode active material is covered with the film described above, the secondary battery has a low internal resistance and a high cycle performance.

As the film forming compound including fluorine and a CC unsaturated bond, for example, a cyclic acid anhydride and/or a cyclic carbonate compound may be used. As the cyclic acid anhydride, for example, a derivative in which hydrogen in maleic anhydride is substituted by fluorine or an alkyl group containing fluorine may be used. As the cyclic carbonate compound, for example, a derivative in which hydrogen in vinylene carbonate or vinyl ethylene carbonate is substituted by fluorine or an alkyl group containing fluorine may be used. In the film forming compound, the CC unsaturated bond may be present either in the cyclic structure or in a substituent bonded to the cyclic structure. A polymerization reaction of the film forming compound is believed to proceed from the CC unsaturated bond functioning as a starting point, and the surface of the positive electrode active material can be covered with a dense polymer film.

Among the film forming compounds, trifluoromethyl maleic anhydride has a reduction potential at approximately +2.5 V with reference to Li (that is, with reference to an oxidation/reduction equilibrium potential of Li⁺/Li) and is easily reductively decomposed. A rate of trifluoromethyl maleic anhydride in the film forming compound is, for example, preferably 80 percent by mass or more, and the film forming compound may be totally formed from trifluoromethyl maleic anhydride.

Under normal battery use conditions, the film forming compound is believed to hardly allow a reduction reaction which forms a film at a positive electrode side to proceed.

However, when the battery is placed in an overdischarge state, the potential of the positive electrode can be decreased to a reduction potential of the film forming compound or less. By an overdischarge treatment, the reduction reaction of the film forming compound proceeds on the positive electrode, and a film excellent in lithium ion conductivity is formed on the surface of the positive electrode active material.

In addition, in the present disclosure, a fully discharge state of a secondary battery indicates a state in which in a predetermined voltage range of a device field which uses a battery, the battery is discharged to a lower limit voltage. The lower limit voltage may be, for example, 2.5 V. The overdischarge treatment indicates a treatment in which the battery is discharged to a voltage state (overdischarge state) less than the lower limit voltage.

In order to suppress a structural change of the positive electrode active material caused by the overdischarge treatment, in the overdischarge treatment, the potential of the positive electrode is also preferably maintained at +2.0 V or more with reference to Li. In other words, the film forming compound preferably has a reduction potential of +2.0 V or more with reference to Li.

On the other hand, by the overdischarge treatment, an oxidation reaction occurs at the negative electrode, and hence, copper foil used as a negative electrode collector is dissolved, and/or polarity inversion in which a negative electrode potential is increased higher than a positive electrode potential may occur in some cases. In order to prevent those described above, a lithium-containing substance having a lithium ion-discharge potential in a range of +2.0 V to +3.5 V with reference to Li may be contained in the negative electrode. Since lithium ions are discharged from the lithium-containing substance in the overdischarge treatment, charges to be consumed at a positive electrode side in the overdischarge treatment can be compensated for.

As the lithium-containing substance which has a lithium ion-discharge potential in the range described above, for example, a phosphoric salt which belongs to the space group Pnma and which contains lithium and a transition metal element MA may be mentioned. As the transition metal element MA, for example, Ni, Fe, Mn, Co, or Cu may be mentioned. As a particular example of the phosphoric salt described above, LiₓFePO₄ (0.5≤x≤1.1) may be mentioned. At most 30% of Fe may be substituted by Al or a transition metal element other than Fe.

As another example of the lithium-containing substance, a composite oxide which belongs to the space group Immm and which contains lithium and a transition metal element MB may be mentioned. As the transition metal element MB, for example, Ni, Fe, Mn, Co, or Cu may be mentioned. As a particular example of the lithium-containing substance described above, Li₂₊ₓNiO₂ (−0.5≤x≤0.3) may be mentioned. At most 30% of Ni may be substituted by Al or a transition metal element other than Ni.

In general, the positive electrode contains a positive electrode collector and a positive electrode active material layer, and the positive electrode active material layer is formed on the positive electrode collector to face the negative electrode with a separator interposed therebetween. In the case described above, the film containing lithium, oxygen, carbon, and fluorine can be formed to cover surfaces of positive electrode active material particles contained in the positive electrode active material layer. When the film is formed by the overdischarge treatment, since the positive electrode active material layer has a porous structure, the film forming compound is able to intrude into voids of the positive electrode active material layer. Hence, the film containing lithium, oxygen, carbon, and fluorine covers not only positive electrode active material particles located in a surface layer of the positive electrode active material layer at a side facing the negative electrode with the separator interposed therebetween but also positive electrode active material particles located inside of the positive electrode active material layer.

When the positive electrode active material layer is composed of a mixture (mixed product) containing the positive electrode active material, a binder (binding agent), and the like, the film containing lithium, oxygen, carbon, and fluorine can partially cover the surface of the binder. When the positive electrode active material layer contains an electrically conductive agent, the film described above can partially cover the surface of the electrically conductive agent. Accordingly, decomposition of an electrolyte component starting from the binder and/or the electrically conductive agent which functions as a starting point can be suppressed.

Furthermore, the film containing lithium, oxygen, carbon, and fluorine can cover a surface of the positive electrode collector. When being viewed in a microscopic manner, the surface of the positive electrode collector is not fully covered with the positive electrode active material and/or the binder and has fine exposed surface areas. Furthermore, a cut end face and/or a lead-fitted portion may be exposed in some cases. The film described above can also be formed on the exposed surface areas of the positive electrode collector. Since the film described above covers the positive electrode collector, the decomposition of the electrolyte component starting from the surface of the positive electrode collector which functions as a starting point can also be suppressed.

The presence of lithium, oxygen, carbon, and fluorine in the film described above can be confirmed by an X-ray photoelectron spectroscopy (XPS) of the surface of the positive electrode recovered from a disassembled secondary battery. XPS is a method to analyze a composition and a chemical bonding state of elements forming a sample surface such that the sample surface is irradiated with X-rays, and kinetic energy of photoelectrons emitted from the sample surface is measured. For energy correction, the C1s spectrum (248.5 eV) of graphite may be used. As a measurement apparatus, for example, the following may be used.

Measurement apparatus: PHI5000VersaProbe, manufactured by ULVAC-PHI, INC.

X-ray source: monochromatic Mg-Kα, 200 nm in diameter, 45 W, 17 kV

Analysis area: approximately 200 μm in diameter

A method for manufacturing a secondary battery according an embodiment of the present disclosure comprises: a step of assembling a secondary battery including a positive electrode, a negative electrode, and an electrolyte and a film forming step of dipping the positive electrode in a solution containing a lithium salt and a film forming compound which includes fluorine and an unsaturated bond between carbons to cover a surface of the positive electrode with a film formed by reductive decomposition of the film forming compound.

As the solution containing a lithium salt and a film forming compound, the electrolyte may be used. For example, the film forming step can be performed such that after the step of assembling a secondary battery, the film forming compound is contained in the electrolyte, and an overdischarge treatment is performed on the secondary battery so as to decrease the potential of the positive electrode to a reduction potential of the film forming compound or less. Alternatively, before the step of assembling a secondary battery or in the formation of a secondary battery, the positive electrode is dipped in the solution containing a film forming compound, and the voltage may be applied to the positive electrode so as to allow a reduction reaction of the film forming compound to proceed. When the voltage is applied, as an electrode forming a pair with the positive electrode, the negative electrode of the same secondary battery may be used, or another electrode (such as a lithium metal) may also be used. In the case described above, the film forming compound may be not contained in the electrolyte of a battery obtained after manufacturing. Since the film forming compound contains fluorine, a film having an excellent oxidation resistance and a low lithium transfer resistance can be formed on the surface of the positive electrode.

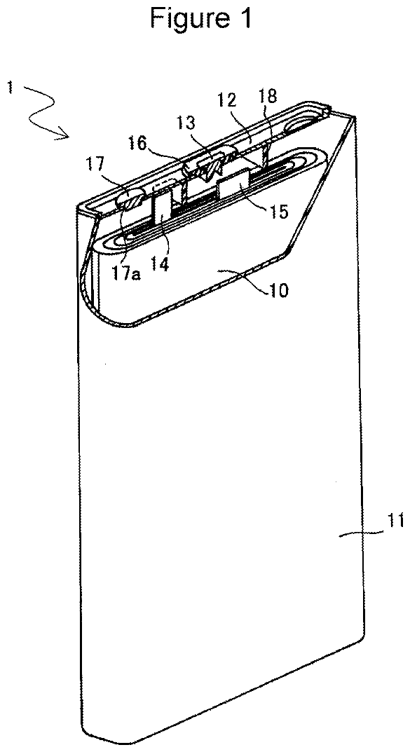

FIG. 1 is a perspective view schematically showing a square type secondary battery according to an embodiment of the present disclosure. In FIG. 1, in order to show the structures of important portions of a secondary battery 1, the secondary battery 1 is shown after being partially notched. In a square type battery case 11, a flat electrode group 10 and an electrolyte (not shown) are received.

The electrode group 10 is formed by winding a sheet-shaped positive electrode and a sheet-shaped negative electrode with at least one separator interposed therebetween. However, in the present disclosure, the type of secondary battery and the shape thereof are not particularly limited. Instead of the winding type electrode group, other electrode groups, such as a laminate type electrode group in which positive electrodes and negative electrodes are laminated to each other with separators interposed therebetween, each may also be used.

To a positive electrode collector of the positive electrode contained in the electrode group 10, one end terminal of a positive electrode lead 14 is connected. The other end terminal of the positive electrode lead 14 is connected to a sealing plate 12 functioning as a positive electrode terminal. To a negative electrode collector, one end terminal of a negative electrode lead 15 is connected, and the other end terminal of the negative electrode lead 15 is connected to a negative electrode terminal 13 provided at approximately the center of the sealing plate 12. Between the sealing plate 12 and the negative electrode terminal 13, a gasket 16 is dispose so as to insulate one from the other. Between the sealing plate 12 and the electrode group 10, a frame body 18 formed from an insulating material is disposed to insulate the negative electrode lead 15 from the sealing plate 12. The sealing plate 12 is bonded to an opening end of the square type battery case 11 to seal the square type battery case 11. In the sealing plate 12, a liquid charge port 17a is formed, and the electrolyte is charged into the square type battery case 11 through the liquid charge port 17a. Subsequently, the liquid charge port 17a is sealed by a sealing plug 17.

(Positive Electrode)

The positive electrode includes a sheet-shaped positive electrode collector and a positive electrode active material layer provided on at least one surface of the positive electrode collector. The positive electrode active material layer may be formed on one surface of the positive electrode collector or on each of two facing surfaces thereof.

(Positive Electrode Collector)

As the positive electrode collector, for example, metal foil or a metal sheet may be mentioned. As a material of the positive electrode collector, for example, stainless steel, aluminum, an aluminum alloy, or titanium may be used. The thickness of the positive electrode collector may be selected, for example, from a range of 3 to 50 μm.

(Positive Electrode Active Material Layer)

The case in which the positive electrode active material layer is composed of a mixture (mixed product) containing positive electrode active material particles will be described. In the positive electrode active material layer, the positive electrode active material particles and a binder are contained as essential components, and as an arbitrary component, an electrically conductive agent may also be contained. The content of the binder contained in the positive electrode active material layer with respect to 100 parts by mass of the positive electrode active material is preferably 0.1 to 20 parts by mass and more preferably 1 to 5 parts by mass. The thickness of the positive electrode active material layer is, for example, 10 to 150 μm.

As the positive electrode active material, a lithium transition metal oxide is preferable. As the transition metal element, for example, Sc, Y, Mn, Fe, Co, Ni, Cu, Cr, Zr, or W may be mentioned. Among those elements mentioned above, for example, Ni, Co, Mn, Fe, Cu, or Cr is preferable, and for example, Mn, Co, or Ni is more preferable. If needed, the lithium transition metal oxide may contain at least one type of typical metal element. As the typical metal element, for example, Mg, Al, Ca, Zn, Ga, Ge, Sn, Sb, Pb, or Bi may be mentioned.

Among the lithium transition metal oxides, in particular, a lithium nickel composite oxide containing Li, Ni, and another metal is preferable since a high capacity can be obtained. As the lithium nickel composite oxide, for example, LiₐNi_{b}M_{1-b}O₂ (M¹ is at least one selected from the group consisting of Mn, Co, and Al, and 0.95≤a≤1.2 and 0.3≤b≤1 are satisfied) may be mentioned. In view of an increase in capacity, the rate b of Ni more preferably satisfies 0.5≤b≤1. When the rate b of Ni is in the range described above, even when overdischarge is performed to a potential of +2.0 V with reference to Li, the structure of the lithium nickel composition oxide is likely to be stably maintained. In view of structural stability in the overdischarge, the lithium nickel composite oxide is further preferably represented by LiₐNi_{b}Mn_{c}Co_{1-b-c}O₂ (0.5≤b≤1 and 0.1≤c≤0.4) in which Mn is contained as M¹).

As a particular example of the lithium nickel composite oxide, for example, there may be mentioned a lithium-nickel-cobalt-manganese composite oxide (such as LiNi_{0.5}Co_{0.2}Mn_{0.3}O₂, LiN_{1/3}Co_{1/3}Mn_{1/3}O₂, or LiNi_{0.4}Co_{0.2}Mn_{0.4}O₂), a lithium-nickel-manganese composite oxide (such as LiNi_{0.5}Mn_{0.5}O₂), a lithium-nickel-cobalt composite oxide (such as LiN_{0.8}Co_{0.2}O₂), or a lithium-nickel-cobalt-aluminum composite oxide (such as LiNi_{0.8}Co_{0.15}Al_{0.05}O₂, LiNi_{0.8}Co_{0.18}Al_{0.02}O₂, or LiNi_{0.08}Co_{0.09}Al_{0.03}O₂).

A compression strength of the lithium nickel composite oxide particles is preferably 250 MPa or more and more preferably 350 MPa or more. When the compression strength of the lithium nickel composite oxide particles is in the range described above, compared to the case in which the compression strength thereof is not in the range described above, cracking of the particles in the overdischarge can be suppressed. In addition, although not particularly limited, for example, an upper limit of the compression strength of the lithium nickel composite oxide particles is preferably 1,500 MPa or less in view of material performance. The compression strength is to be measured by a method in accordance with JIS-R1639-5.

That is, a particle compression test of the present disclosure is a test in which after a positive electrode slurry containing the composite oxide particles, an electrically conductive material, a binding material, and the like is applied on a positive electrode collector and is then dried to form a positive electrode active material layer, the positive electrode active material layer thus obtained is compressed to have a mixture density of 3.4 g/cm³.

The surface of the positive electrode active material particle is covered with the film which contains lithium, oxygen, carbon, and fluorine and which has a high lithium ion conductivity and an excellent oxidation resistance. The film described above is not likely to be decomposed by oxidation during charge performed at a high voltage and may not disturb lithium transfer during charge/discharge. Accordingly, even after the charge/discharge is repeatedly performed many times, the decomposition reaction of the electrolyte component at the surface of the positive electrode active material can be effectively suppressed. As a result, even after charge/discharge cycles are performed many times, the capacity can be maintained high, and a long-life battery can be obtained. In addition, a battery having a low internal resistance can be obtained.

The thickness of the film is, for example, 10 to 200 nm.

When the film containing lithium, oxygen, carbon, and fluorine is formed by an overdischarge treatment of the battery, for example, at contact interfaces between the positive electrode active material particles and adhesion interfaces between the positive electrode active material particles and the binder, regions on which the film is not formed may be present.

In order to enhance a filling property of the positive electrode active material in the positive electrode active material layer, the average particle diameter (D50) of the positive electrode active material particles is preferably sufficiently small as compared to the thickness of the positive electrode active material layer. The average particle diameter (D50) of the positive electrode active material particles is, for example, preferably 5 to 30 μm and more preferably 10 to 25 μm. In addition, the average particle diameter (d50) indicates a median diameter at a cumulative volume of 50% in a volume-basis particle size distribution. The average particle diameter is measured, for example, using a laser diffraction/scattering type particle size distribution meter.

As the binder (binding agent), for example, there may be mentioned a fluorine resin, such as a poly(vinylidene fluoride) (PVdF), a polytetrafluoroethylene (PTFE), or a tetrafluoroethylene-hexafluoropropylene copolymer (HFP); an acrylic resin, such as a poly(methyl acrylate) or an ethylene-methyl methacrylate copolymer; a rubber material, such as a styrene-butadiene rubber (SBR) or an acrylic rubber; or a water-soluble polymer, such as a carboxymethyl cellulose (CMC) or a poly(vinyl pyrrolidone).

As the electrically conductive agent, a carbon black, such as acetylene black or Ketjen black, is preferable.

The positive electrode active material layer can be formed such that after a positive electrode slurry is prepared by mixing the positive electrode active material particles, the binder, and the like with a dispersant, the positive electrode slurry is applied on a surface of the positive electrode collector, is then dried, and is further rolled. As the dispersant, for example, water, an alcohol such as ethanol, an ether such tetrahydrofuran, or N-methyl-2-pyrrolidone (NMP) may be used. When water is used as the dispersant, as the binder, the rubber material and the water-soluble polymer are preferably used in combination.

(Negative Electrode)

The negative electrode includes a sheet-shaped negative electrode collector. The negative electrode may further include a negative electrode active material layer provided on a surface of the negative electrode collector. The negative electrode active material layer contains a negative electrode active material which can occlude and release lithium. The negative electrode active material layer may be formed on one surface of the negative electrode collector or on each of two facing surfaces thereof.

(Negative Electrode Collector)

As the negative electrode collector, for example, there may be mentioned metal foil, a metal sheet, a mesh body, a punching sheet, or an expanded metal. As a material of the negative electrode collector, for example, stainless steel, nickel, copper, or a copper alloy may be used. The thickness of the negative electrode collector may be selected, for example, from a range of 3 to 50 μm.

(Negative Electrode Active Material Layer)

The negative electrode active material layer can be formed using a negative electrode slurry which contains the negative electrode active material, a binder (binding agent), and a dispersant by a method in accordance with the method for manufacturing a positive electrode active material layer. The negative electrode active material layer may also contain, if needed, an arbitrary component, such as an electrically conductive agent. The content of the binder contained in the negative electrode active material layer with respect to 100 parts by mass of the negative electrode active material is preferably 0.1 to 20 parts by mass and more preferably 1 to 5 parts by mass. The thickness of the negative electrode active material layer is, for example, 10 to 150 μm.

The negative electrode active material may be either a non-carbon material or a carbon material or may be formed using both of them in combination. Although the carbon material used as the negative electrode active material is not particularly limited, for example, at least one selected from the group consisting of graphite and hard carbon is preferable. Among those mentioned above, since having a high capacity and a small irreversible capacity, graphite is promising.

In addition, the graphite is a generic name of carbon materials having a graphite structure and includes a natural graphite, an artificial graphite, an expanded graphite, graphitized mesophase carbon particles, or the like. As the natural graphite, for example, a flaky graphite or an earthy graphite may be mentioned. In general, a carbon material in which an interplanar spacing d₀₀₂ of the 002 plane of a graphite structure calculated from an X-ray diffraction spectrum is 3.35 to 3.44 Å is classified in graphite. On the other hand, the hard carbon is a carbon material in which fine graphite crystals are arranged in random directions and are hardly further graphitized, and the interplanar spacing d₀₀₂ of the 002 plane is larger than 3.44 Å.

As the non-carbon material used as the negative electrode active material, an alloy-based material is preferable. The alloy-based material preferably contains at least one selected from silicon, tin, Ga, and In, and in particular, a single silicon element or a silicon compound is preferable. The silicon compound includes at least one of a silicon oxide and a silicon alloy. As the negative electrode active material, a lithium metal or a lithium alloy may also be used.

The lithium-containing substance may be contained in the negative electrode active material layer. The lithium-containing substance preferably has a lithium ion-discharge potential in a range of +2.0 V to +3.5 V with reference to Li. When the film is formed on the positive electrode surface by an overdischarge treatment, since lithium contained in the lithium-containing substance is dissolved in an electrolyte liquid, the lithium-containing substance prevents degradation caused by dissolution of the negative electrode collector (such as copper foil). As the lithium-containing substance, a material which is able to discharge lithium ions at a relatively low potential and which can be used as a positive electrode active material of a lithium secondary battery may be used. For example, there may be mentioned a phosphoric salt (such as LiₓFePO₄ (0.5≤x≤1.1)) which belongs to the space group Pnma and which contains lithium and a transition metal element or a composite oxide (such as Li₂₊ₓNiO₂ (−0.5≤x≤0.3)) which belongs to the space group Immm and which contains lithium and a transition metal element.

(Separator)

As the separator, a resin-made fine porous film, a non-woven cloth, or a woven cloth may be used. As the resin, for example, a polyolefin, such as a polyethylene (PE) or a polypropylene (PP), a polyamide, or a poly(amide imide) may be used.

(Electrolyte)

The electrolyte contains a solvent, a solute dissolved in the solvent, and a film forming compound. The electrolyte may also contain at least one known additive. The film forming compound may be a compound which includes fluorine and an unsaturated bond between carbons, and for example, trifluoromethyl maleic anhydride is preferably used.

As the solvent, for example, there may be mentioned water or a nonaqueous solvent, such as a cyclic carbonate ester, a chain carbonate ester, a cyclic carboxylic acid ester, or a chain carboxylic acid ester. Those solvents may be used alone, or at least two types thereof may be used in combination.

As the cyclic carbonate ester, for example, ethylene carbonate (EC), fluoroethylene carbonate (FEC), propylene carbonate (PC), butylene carbonate, vinylene carbonate, vinyl ethylene carbonate, or a derivative thereof may be used. Those may be used alone, or at least two types thereof may be used in combination. In view of ion conductivity of the electrolyte, at least one selected from the group consisting of ethylene carbonate, fluoroethylene carbonate, and propylene carbonate is preferably used.

As the chain carbonate ester, for example, diethyl carbonate (DEC), ethyl methyl carbonate (EMC), or dimethyl carbonate (DMC) may be mentioned.

In addition, as the cyclic carboxylic acid ester, for example, γ-butyrolactone (GBL) or γ-valerolactone (GVL) may be mentioned.

As the chain carboxylic acid ester, for example, methyl acetate (MA), ethyl acetate (EA), propyl acetate, methyl propionate, ethyl propionate, propyl propionate, or a fluorinated material thereof may be mentioned. As the fluorinated material of the chain carboxylic acid ester, in view of viscosity and the like, methyl 3,3,3-trifluoropropionate (FMP) or 2,2,2-trifluoroethyl acetate (FEA) is preferably used.

Although the solvents mentioned above are each not generally reduced at a potential of 2.0 V or more with reference to Li, when the film forming compound is reduced in the overdischarge, its reductively decomposed product and the solvent mentioned above are able to react with each other. Hence, in the film to be formed on the positive electrode in the overdischarge, the component of the above solvent can be contained.

In order to contain many fluorine elements in the film formed on the positive electrode, as the solvent, a fluorinated solvent containing fluorine, oxygen, and carbon is preferably used. A rate of the fluorinated solvent containing fluorine, oxygen, and carbon with respect to the total solvent may be, for example, 30 to 100 percent by mass. Accordingly, a film having a high oxidation resistance can be formed on the positive electrode.

As the fluorinated solvent containing fluorine, oxygen, and carbon, in view of ion conductivity of the electrolyte and the like, at least one selected from the group consisting of fluoroethylene carbonate (FEC), methyl 3,3,3-trifluoropropionate (FMP), and 2,2,2-trifluoroethyl acetate (FEA) is preferable.

As the solute, various lithium salts may be used. The concentration of a lithium salt in the electrolyte is, for example, 0.5 to 2 mol/L. As the lithium salt, for example, LiPF₆, LiBF₄, LiClO₄, LiAsF₆, LiCF₃SO₃, LiN(SO₂F)₂, or LiN(SO₂CF₃)₂ may be mentioned. The lithium salt may be used alone, or at least two types thereof may be used in combination.

### EXAMPLES

Hereinafter, with reference to examples and comparative example, although the secondary battery according to the present disclosure will be described in detail, the present disclosure is not limited to the following examples.

### Example 1

By the following procedure, a positive electrode-evaluation secondary battery in which metal Li was used as a counter electrode was formed.

(1) Formation of Positive Electrode

After a lithium transition metal oxide (LiNi_{0.60}Co_{0.20}Mn_{0.20}O₂ (NCM)) as a positive electrode active material, an acetylene black (AB) as an electrically conductive agent, a poly(vinylidene fluoride) (PVdF) as a binder were mixed together at a mass ratio of NCM:AB:PVdF of 100:1:0.9, an appropriate amount of N-methyl-2-pyrrolidone (NMP) was further added, followed by stirring, so that a positive electrode slurry was prepared. Subsequently, after the positive electrode slurry thus obtained was applied to one surface of aluminum foil (positive electrode collector) and was then dried, a coating film of a positive electrode active material layer was rolled using a roller machine. The amount of a mixed product per unit area of an electrode plate thus prepared was 8.0 mg/cm².

A laminate of the positive electrode collector and the positive electrode active material layer thus obtained was cut into a predetermined electrode size, so that a positive electrode including the positive electrode active material layer on one surface of the positive electrode collector was obtained.

(2) Preparation of Electrolyte

First, one part by mass of vinylene carbonate and one part by mass of trifluoromethyl maleic anhydride were added to 100 parts by mass of a mixture liquid containing FEC and FMP at a mass ratio of 15:85, so that a nonaqueous solvent was obtained. In the nonaqueous solvent, LiPF₆ was dissolved at a concentration of 1.0 mol/L, so that a nonaqueous electrolyte was prepared.

(3) Assembly of Battery

Lead wires were fitted respectively to the positive electrode obtained as described above and the Li metal counter electrode. An electrode body was formed so that the positive electrode and the Li metal counter electrode faced each other with a separator interposed therebetween, the separator having a thickness of 0.015 mm and containing a PP and a PE. The electrode body was sealed in an aluminum laminate film-made exterior package together with the nonaqueous electrolyte, so that a secondary battery A1 was assembled.

(4) Overdischarge Treatment

An overdischarge treatment was performed on the secondary battery A1 at a constant current of 13 mA/g (per unit mass of the positive electrode active material) until a closed circuit voltage of the battery reached to 2.0 V (with reference to Li counter electrode).

The positive electrode was recovered from the secondary battery A1 on which the overdischarge treatment was performed, and after the nonaqueous electrolyte was sufficiently washed out with dimethyl carbonate, the positive electrode was dried. Subsequently, when an XPS analysis was performed on the surface of the positive electrode, an oxygen (O-1s) spectrum observed in a binding energy of 525 to 536 eV, a carbon (C-1s) spectrum observed in a binding energy of 280 to 295 eV, and a fluorine (F-1s) spectrum observed in a binding energy of 680 to 690 eV were each detected. From the oxygen spectrum, a peak caused by the bond between oxygen and a transition metal derived from the positive electrode active material and a peak caused by the bond between carbon and oxygen were confirmed in a range of 528 to 530 ev and in a range of 530 to 536 eV, respectively. From the carbon spectrum, peaks caused by the bond between carbons and the bond between carbon and hydrogen and a peak caused by the bond between carbon and fluorine were confirmed in a range of 282 to 288 ev and in a range of 288 to 293 eV, respectively. In addition, from the fluorine spectrum, a peak caused by the bond between fluorine and carbon and a peak caused by the bond between fluorine and lithium were confirmed in a range of 686 to 690 ev and in a range of 683 to 686 eV, respectively.

(5) Evaluation

[Evaluation 1: Internal Resistance Measurement]

Under the conditions shown in the following charge 1 and discharge 1, initial charge/discharge was performed. The charge/discharge was performed in an environment at 25° C.

(Charge 1)

Constant current charge was performed at 80 mA/g (per unit mass of the positive electrode active material) until the closed circuit voltage of the battery reached to 4.2 V. Subsequently, constant voltage charge was performed at 4.2 V until the current reached to less than 13 mA/g (per unit mass of the positive electrode active material).

(Discharge 1)

Constant current discharge was performed at 130 mA/g (per unit mass of the positive electrode active material) until the closed circuit voltage of the battery reached to 2.5 V. Subsequently, constant current discharge was again performed at 13 mA/g (per unit mass of the positive electrode active material) until the closed circuit voltage of the battery reached to 2.5 V.

After the battery processed by the initial charge/discharge was again charged under the same conditions as those of Charge 1 and was then connected to an LCR meter, an absolute value |Z| of an impedance at 1 Hz was measured. The measured value was multiplied by an electrode surface, and an impedance per unit electrode area was evaluated.

[Evaluation 2: Cycle Characteristics]

After the initial charge/discharge was performed, under the conditions shown in the following charge 2 and discharge 2, the charge/discharge was performed at least two times. The charge/discharge was performed in an environment at 45° C. In the charge 2, as described below, since the charge was performed at a higher voltage condition than a normal condition, degradation of the positive electrode was accelerated.

(Charge 2)

Constant current charge was performed at 80 mA/g (per unit mass of the positive electrode active material) until the closed circuit voltage of the battery reached to 4.8 V. Subsequently, constant voltage charge was performed at 4.8 V until the current reached to less than 13 mA/g (per unit mass of the positive electrode active material).

(Discharge 2)

Constant current discharge was performed at 130 mA/g (per unit mass of the positive electrode active material) until the closed circuit voltage of the battery reached to 2.5 V. Subsequently, constant current discharge was again performed at 13 mA/g (per unit mass of the positive electrode active material) until the closed circuit voltage of the battery reached to 2.5 V.

The charge/discharge cycle described above was repeatedly performed 30 times, and a rate (%) of a discharge capacity at a 30^{th} cycle to the initial discharge capacity was evaluated as a capacity retention rate X₃₀.

### Comparative Example 1

Except for that in the preparation of the nonaqueous electrolyte, trifluoromethyl maleic anhydride was not added, a secondary battery B1 was assembled by a method similar to that of Example 1. In addition, the overdischarge treatment was not performed.

The secondary battery B1 thus assembled was evaluated in a manner similar to that of Example 1.

### Comparative Example 2

In the preparation of the nonaqueous electrolyte, 1 part by mass of maleic anhydride was added instead of trifluoromethyl maleic anhydride. Except for that described above, a secondary battery B2 was formed by a method similar to that of Example 1. In addition, the secondary battery B2 processed by the overdischarge treatment was evaluated in a manner similar to that of Example 1.

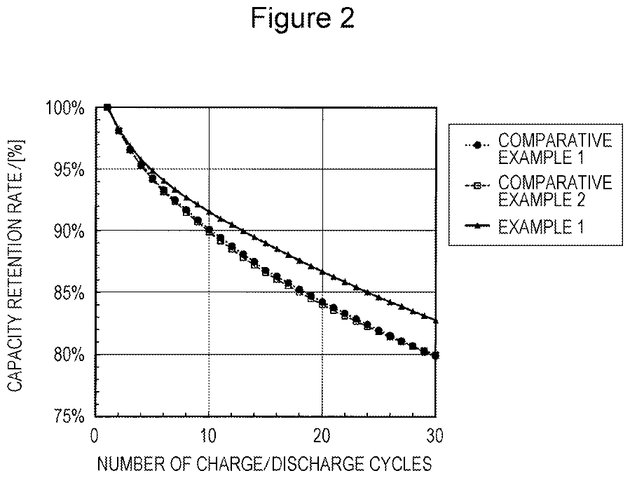

The evaluation results of Example 1 and Comparative Examples 1 and 2 are shown in Table 1. In addition, in FIG. 2, the change of a capacity retention rate Xₙ at each charge/discharge cycle is shown.

TABLE 1

| | | CAPACITY | |
|---|---|---|---|
| | FILM FORMING | RETENTION | IMPEDANCE |
| CELL | COMPOUND | RATE X₃₀ (%) | (Ω · cm²) |
| A1 | TRIFLUOROMETHYL | 82 | 32 |
| | MALEIC ANHYDRIDE | | |
| B1 | NONE | 80 | 43 |
| B2 | MALEIC ANHYDRIDE | 80 | 35 |

As shown in Table 1, compared to the secondary batteries B1 and B2 of Comparative Examples 1 and 2, respectively, the secondary battery A1 of Example 1 has a high capacity retention rate and a low resistance.

The capacity retention rate of the battery B2 after 30 cycles was approximately the same as that of the battery B1 in which no film was formed by the film forming compound. In addition, as shown in FIG. 2, the capacity retention rates of the batteries B1 and B2 show approximately the same change of the capacity retention rate in association with the repetition of charge/discharge cycles. The reason for this is believed as described below.

In the battery B2, by the overdischarge treatment, a film is formed on the positive electrode from a reductively decomposed product of maleic anhydride. However, it is believed that since no fluorine is contained in this film, the oxidation resistance thereof is low, the film is decomposed by oxidation at an early stage, and as a result, the capacity retention rate cannot be improved. On the other hand, it is estimated that since a low resistant film remains at the initial stage of the charge cycles, the initial impedance is decreased.

On the other hand, in the battery A1, the film derived from the reductive decomposition of trifluoromethyl maleic anhydride is formed on the positive electrode surface by the overdischarge treatment. The film described above has an oxidation resistance and also has an excellent lithium ion conductivity. Accordingly, it is believed that a decrease in capacity retention rate is suppressed, and the internal resistance can be decreased.

Although the present invention has been described with reference to the preferable embodiments at the moment, the disclosure as described above is not to be limitedly understood. Various changes and/or modifications will be surely apparent to a person skilled in the art when the disclosure described above is read thereby. Hence, the attached claims are to be understood to include any changes and/or modifications which are not departing from the spirit and the scope of the present invention.

### INDUSTRIAL APPLICABILITY

The secondary battery according to the present disclosure is useful as a drive power source for a personal computer, a cellular phone, a mobile device, a personal digital assistant (PDA), a mobile game machine, a video camera, or the like; a main power source or an auxiliary power source for an electric motor used in a hybrid electric car, a plug-in HEV, or the like; or a drive power source for an electric tool, a vacuum cleaner, a robot, or the like.

### REFERENCE SIGNS LIST

1: secondary battery, 10: winding type electrode group, 11: square type battery case, 12: sealing plate, 13: negative electrode terminal, 14: positive electrode lead, 15: negative electrode lead, 16: gasket, 17: sealing plug, 17a: liquid charge port, 18: frame body

1. A secondary battery comprising:
a positive electrode containing a positive electrode active material; a negative electrode; and an electrolyte,
wherein the electrolyte contains a solvent, a lithium salt dissolved in the solvent, and a film forming compound,
the film forming compound includes fluorine and an unsaturated bond between carbons and is a compound to be reduced at a potential of +2.0 V or more with reference to Li, and
a surface of the positive electrode active material is at least partially covered with a film containing lithium, oxygen, carbon, and fluorine.

2. The secondary battery according to claim 1,
wherein the film forming compound is at least one of a cyclic acid anhydride and a cyclic carbonate compound.

3. (canceled)

4. The secondary battery according to claim 1,
wherein the film forming compound includes trifluoromethyl maleic anhydride.

5. The secondary battery according to claim 1,
wherein the film containing fluorine contains a reductively decomposed product of the film forming compound.

6. The secondary battery according to claim 1,
wherein the negative electrode contains a lithium-containing substance which has a lithium-ion discharge potential in a range of +2.0 V to +3.5 V with reference to Li.

7. The secondary battery according to claim 6,
wherein the lithium-containing substance contains at least one of a phosphoric salt which belongs to the space group Pnma and which contains lithium and a transition metal element MA and a composite oxide which belongs to the space group Immm and which contains lithium and a transition metal element MB.

8. The secondary battery according to claim 1,
wherein the positive electrode active material contains a lithium nickel composite oxide represented by LiₐNi_{b}M¹_{1-b}O₂,
M¹ is at least one selected from the group consisting of Mn, Co, and Al, and
0.95≤a≤1.2 and 0.5≤b≤1 are satisfied.

9. The secondary battery according to claim 8,
wherein the lithium nickel composite oxide is represented by LiₐNi_{b}Mn_{c}Co_{1-b-c}O₂, and
0.1≤c≤0.4 is satisfied.

10. The secondary battery according to claim 8,
wherein the lithium nickel composite oxide is composed of particles having a compression strength of 250 MPa to 1,500 MPa.

11. The secondary battery according to claim 1,
wherein the solvent contains a fluorinated solvent containing fluorine, oxygen, and carbon, and
a rate of the fluorinated solvent with respect to 100 parts by mass of the solvent is 30 to 100 parts by mass.

12. The secondary battery according to claim 11,
wherein the fluorinated solvent includes at least one selected from the group consisting of fluoroethylene carbonate, methyl 3,3,3-trifluoropropionate, and 2,2,2-trifluoroethyl acetate.

13. A method for manufacturing a secondary battery, comprising:
a step of assembling a secondary battery including a positive electrode, a negative electrode, and an electrolyte; and
a film forming step of dipping the positive electrode in a solution containing a lithium salt and a film forming compound which includes fluorine and an unsaturated bond between carbons to cover a surface of the positive electrode with a film formed by reductive decomposition of the film forming compound.

14. The method for manufacturing a secondary battery according to claim 13,
wherein the solution is the electrolyte, and
the film forming step includes, after the step of assembling a secondary battery, a step of performing an overdischarge treatment on the secondary battery until the potential of the positive electrode reaches to a reduction potential of the film forming compound or less.
